(19) United States
(12) Patent Application Publication
(10) Pub. No.: US 2010/0038269 A1
(43) Pub. Date: Feb. 18, 2010

(54) Memory card holder

(76) Inventor: Jimmy Picard, Fort Myers, FL (US)

Correspondence Address: George DiVincenzo, 11407 Waterford Village Drive, Fort Myers, FL, 33913, US

(21) Appl. No.: 12/583,056

(22) Filed: Aug. 13, 2009

Related U.S. Application Data
(60) Provisional application No. 61/188,940, filed on Aug. 14, 2008.

(51) Int. Cl. G11B 33/04; B65D 1/24

(52) U.S. Cl. 206/307.1; 206/307; 220/523

(57) ABSTRACT

The memory card holder disclosed is a portable, credit card sized storage device that can be conveniently placed in a wallet, purse or carrying case that includes an outer portion or cover consisting of top, bottom and rear segments, the front and sides of the memory card holder which includes notches of variable sizes to accept different sized memory cards, a core organizer within the interior of the card holder that provides support for the outer portions of the card holder and defines specific apertures to accept a plurality of different sized memory cards, removable sleeves, nesting adapters and mini-wallet inserts that will allow users to configure the storage device to be compatible with their specific needs. The memory card holder can store a plurality of memory cards as many as nineteen in all and provides a secure means to store and protect memory cards.

### RELATED US APPLICATION DATA

Provisional Application No. 61/188,940 filed on Aug. 14, 2008.

### FIELD OF THE INVENTION

The present invention discloses a portable credit card sized memory card holder that can hold a plurality of memory cards and Memory Sticks and is conveniently adaptable to a variety of different sized memory cards.

### BACKGROUND OF THE INVENTION

There is currently a proliferation in the marketplace of hand held portable electronic devices such as mobile personal computers, digital cameras, video recorders, personal digital assistants (PDAs), music (MP3) players, eBook readers, video game players, cell phones, and other electronic devices. These types of products require the use of memory cards, often referred to as flash memory cards, a description for a solid-state electronic data storage device. There are numerous types and configurations of memory cards available today such as PC (PCMCIA) cards which were the first format that was quickly followed by compact flash (CF), smart media (SM/SMC), memory sticks (MS), multimedia cards, micro cards (MMC), secure digital (SD) cards, universal flash storage (UF), mini SD cards, micro SD cards, intelligent sticks (iStick), Memory Stick PRO (MSP), and Memory Stick PRO Duo (MSPD), Micro M2 cards and many more. The trend is clearly towards miniaturization.

With the combined aspects of miniaturization with regards to the size of memory cards and the improvements in the data storage capacity of memory cards, there is an ever increasing need for portable storage devices that accommodate the many common formats that are utilized in memory cards. As more portable devices such as digital cameras, camcorders, voice recorders, MP-3 and MP-4 players, PDAs and cell phones utilize different formats for their memory cards, there is a need for a convenient means to carry extra memory cards providing an enhanced ability to organize, exchange, use and read the data stored on memory cards. What is particularly needed in view of the above is a user friendly, versatile and convenient credit card sized memory card holder that will allow data to be easily transported and will enable data to be uploaded at remote locations.

Previous memory card storage devices are somewhat limited in their design and utility. Many existing products offer storage capabilities that are not compact, versatile or conveniently portable.

### DESCRIPTION OF THE PRIOR ART

There have been several patent applications that have published and patents that have issued disclosing memory card storage devices.

U.S. Pat. No. 6,120,228 discloses a wallet sized pocket booklet that was designed to fit within the credit card compartment of a wallet or a similar type card holder. The pocket booklet included a cover consisting of a fold, a front and a back panel, a plurality of interior leaves attached to the fold forming pages, glue strips perpendicular to the fold forming at least one pocket that forms an opening for a memory card.

Japanese Publication No. 2001101360 disclosed portable credit card sized housing case for a semiconductor memory card holding up to six memory cards. The holder consisted of predetermined sized slots in which memory cards could be inserted.

U.S. Pat. No. 6,275,383 disclosed a device for the storing electronic data storage cards comprising a rim member defining a storage compartment, the compartment having an insertion guide so that the storage card is slidable into the compartment. The storage device has a plurality of holding guides that are around and define the circumference of the storage compartment and have structures that engage against the edges of the storage card to align and position the card within the compartment.

U.S. Pat. No. D 453,515 disclosed an ornamental design for an electronic memory card holder in which a single memory card could be inserted.

US Patent Application Publication No. 2003/0166360 disclosed an credit card sized apparatus for storing and protecting interchangeable modules (memory cards) and method of manufacturing the same comprising an apparatus for storing at least one memory card with a conjoined core layer and side pieces having at least one opening formed in the core layer which can slidably receive a memory card. The apparatus can thereby safely store at least one memory card in a credit card sized slot in a wallet, purse, briefcase or other carrying device.

U.S. Patent Application Publication No. 2005/0150961 disclosed a memory card holding device configured to hold a plurality of memory cards of variable sizes within a case, a cavity formed within the case and a retaining mechanism positioned within the cavity to retain a memory card. The memory cards are held safely within the case by a retaining structure such as a clip.

U.S. Patent Application Publication No. 2008/0156676 disclosed a memory card holder and organizer providing consumers with a compact and convenient means for storing their flash memory cards for a means for cataloging the contents of their memory cards. An individual memory card holder includes a piece of paper, cardboard or other stock to which is affixed a memory card pocket for holding a memory card. The stock further includes an indexing space next to the memory card pocket which indexing space may have lines printed on the stock for a user to provide a description of the contents of the memory card stored in the pocket.

U.S. Patent Publication No. 2008/0173598 disclosed an apparatus for storing a plurality of memory devices (up to six devices in all) comprising a portable holder, a plurality of receiving recesses each adapted to receiving one memory device, a plurality of holding elements that are removable and that holder body does not electrically interfere with the memory cards.

Japanese Publication No. 2008/126439 disclosed a holder for keeping memory cards to which information showing the stored contents can be attached. The holder has memory card pockets for storing the memory cards.

U.S. Pat. No. D 592,667 disclosed an ornamental design of a memory card holder that holds up to two memory cards.

U.S. Pat. No. 7,475,816 disclosed a protective case for a plurality of different sized memory cards that includes a rigid exterior container having exterior dimensions of length, width and thickness distinct from each other comprising a rigid exterior container with two shells held by a latch means, resilient inserts dimensioned to nest within the exterior shells, and the inserts each define five memory card securing means for securing different sized memory cards against unsecure removal from the case.

U.S. Design Pat. No. D 593,561 disclosed an ornamental design for a memory card holder the memory cards that includes an outer casing at holds up to two memory cards in a rigid case.

U.S. Patent Application Publication No. 2009/00143344 disclosed a memory card case for holding a plurality of memory cards. The memory card case includes an outer casing and interior memory card holders that are connected to the outer casing and also includes a pocket to hold the memory card.

### SUMMARY OF THE INVENTION

There is a need today to have access to memory cards for use in portable electronic devices such as cameras, PDAs, etc. The present invention enables one to store and organize a plurality of memory cards, up to 19 memory cards in all, in a convenient portable credit card sized holder that can be easily stored in one's wallet, purse, handbag or briefcase. Different sized memory cards can be stored with the use of specifically designed sleeves and uniquely designed mini-wallet carriers the latter for micro memory cards that adds versatility unseen in previous memory card storage devices. The present invention includes a credit card sized memory card holder, a core organizer that enables different sized memory cards to be stored and to provide some rigidity and stability to the outer case, notched slots to hold the memory cards in place, variably sized sleeves to accommodate memory cards of differing sizes. The memory card holder has a spine located mid-way and perpendicular to the front exterior edges of the memory card holder. The memory card holder is designed with differentially recessed areas to enable memory cards to be inserted and removed with ease. Specific details of the present invention are shown in the figures below and other aspects of the invention will become apparent from the description of the preferred embodiments.

### BRIEF DESCRIPTION OF THE DRAWING

FIG. 1 is a wire frame view of the portable, credit card sized memory card holder showing a cover, a core organizer, upper and lower notches, a rear spine and insertion compartments for the storage of memory cards

FIG. 2 is an expanded view of the memory card holder showing the cover, the core organizer and several aspects of the present invention including the insertion compartments

FIG. 3 is a prospective top and front view of a portable, credit card sized memory card holder showing a card holder cover, upper and lower notches, a partial view of the core organizer, the rear spine and the openings for the insertion of various sized memory cards into insertion compartments

FIG. 4 is a prospective view of the bottom surface of the memory card holder showing the lower notches on the bottom and sides of the memory card holder

FIG. 5 is an elevational rear view of the rear spine of the memory card holder including the spine surface indentation

FIG. 6 shows the core organizer dimensions

FIG. 7 is a prospective expanded view of the memory card holder, the core organizer, insertion compartments, insert sleeves, adapters and mini-wallet container

FIG. 8 is an expanded view of the mini wallet showing the location of the inserted memory cards

FIG. 9 is an elevational front view of the storage sleeve

### DESCRIPTION OF THE PREFERRED EMBODIMENTS

All the drawings are intended to illustrate the preferred embodiments of the present invention and do not in any way limit the scope of the invention.

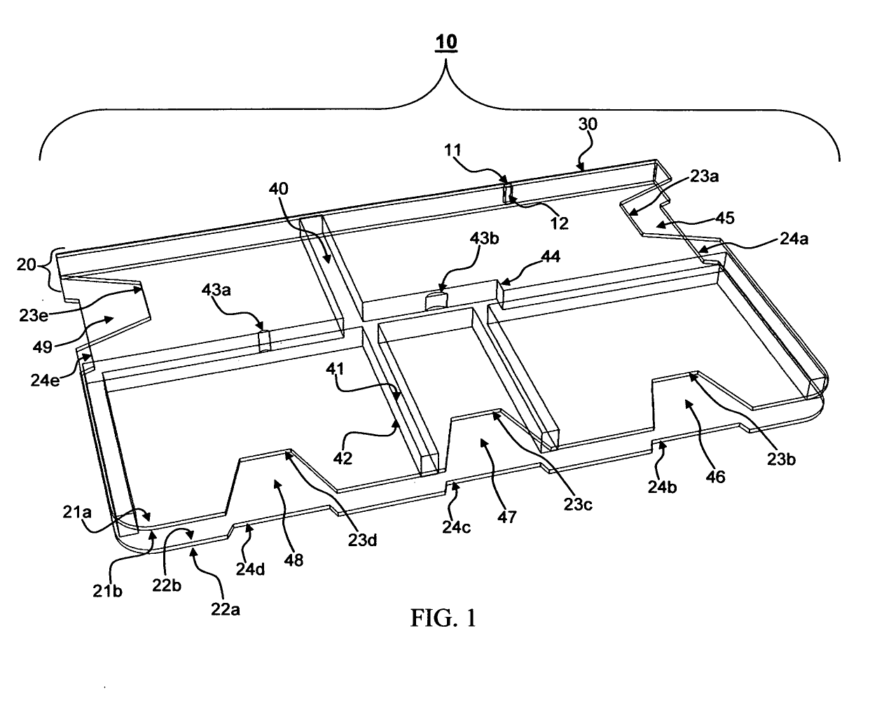

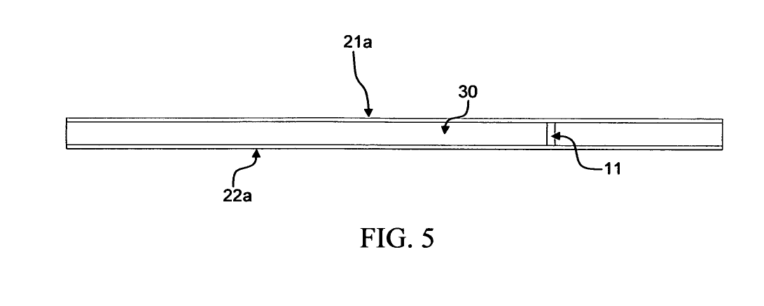

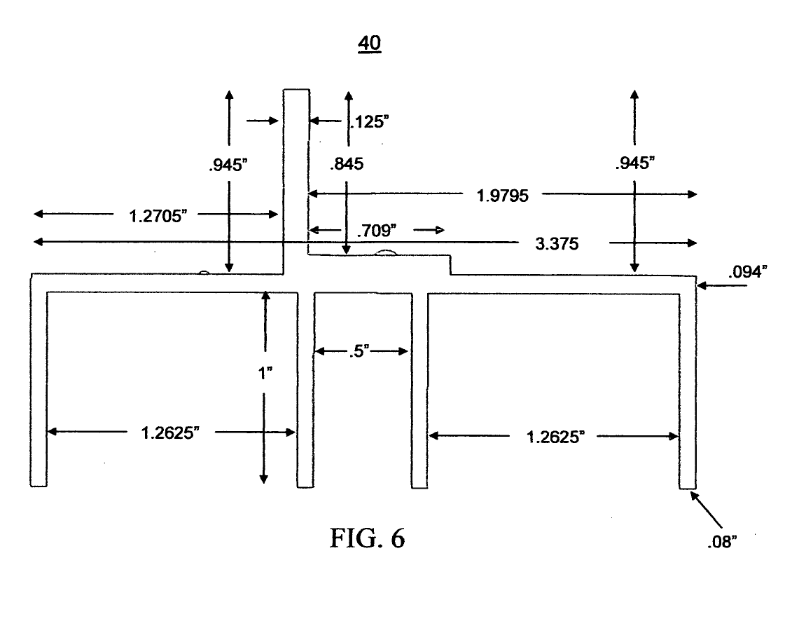

In FIG. 1, is shown a wire frame view of a portable credit card sized memory card holder 10 that includes a cover 20, comprising two parallel exterior 21a and 22a and interior 21b and 22b surfaces, a semi-rigid rear spine 30 that has a degree of flexibility to provide resistance for memory cards until seated and latched by the catch, a plurality of insertion compartments 45-49 in which memory cards may be inserted and or removed, said insertion compartments are defined by upper cover notches 23 a, b, c, d and e (right to left), and lower notches 24 a, b, c, d and e (right to left), the upper notches 23 are larger and deeper than the lower notches 24 to enable the memory cards to be inserted and removed from the memory card cover 20 with ease. Upper notches 23a and 23e are larger in size than notches 23 b, 23c and 23d. Specific dimensions for the core organizer are shown in FIG. 6. A partial view of the core organizer 40 shown that provides rigidity to the outer cover 20 and defines the dimensions of insertion compartments 45-49 into which memory cards are inserted and removed. The cover 20 and the core organizer 40 in one embodiment are made of a polymeric plastic but are not limited to this material or can be made of metallic components as well as other materials. The core organizer 40 provides upper and lower planar surfaces in which an appropriate adhesive is applied to the upper surface 41 and lower surface 42 to bond the upper surface 41 and lower surface 42 to the interior surface of the memory card cover 20. This is described more fully in FIG. 5. The memory card holder 10 is designed to accommodate a plurality of different sized memory cards such as USB Card Readers, SD cards, Memory Sticks, micro SD cards, M2 Micro Memory Sticks, Mini SD cards, Memory Stick PRO Duo and XD cards. The present invention is not limited to the memory cards referenced above. The memory card cover 20 can include a logo or other promotional material placed on its surface. As is shown in FIG. 1 the memory card holder 10 has rounded edges at the front corners of cover 20 to enable holder 10 to be stored and removed easily from wallets and other stored devices. The removal of stored memory cards is achieved easily by placing the fore finger and the thumb on the memory card and gently pulling out the memory card from the insertion compartment. The memory card holder 10 core organizer 40 is approximately ⅛″ thick and made of acrylic or an equivalent material to provide structural integrity. The core organizer 40 can be injection molded or laser cut to the specific shape required. The core organizer 40 upper surface 41 is glued to the top interior surface 21b of the Memory Card cover 20 with an appropriate epoxy. The core organizer 40 lower surface 42 is glued to the bottom interior surface 22b of the Memory Card cover 20 with an appropriate epoxy. The Memory Card cover 20 is made of a 20 mil laminate composite and is die cut to the appropriate shape needed to provide the upper notches 23a-23e and lower notches 24a-24e. The rear spine 30 is created by scoring the card during the die cutting process. Alternately the score lines can be cut by laser. The memory card cover 20 is folded 90 degrees at each score and wraps around the core organizer 40 where it is then bonded by epoxy as previously described. Alternately the memory card holder 10 may be formed in one piece through a plastic injection molding process.

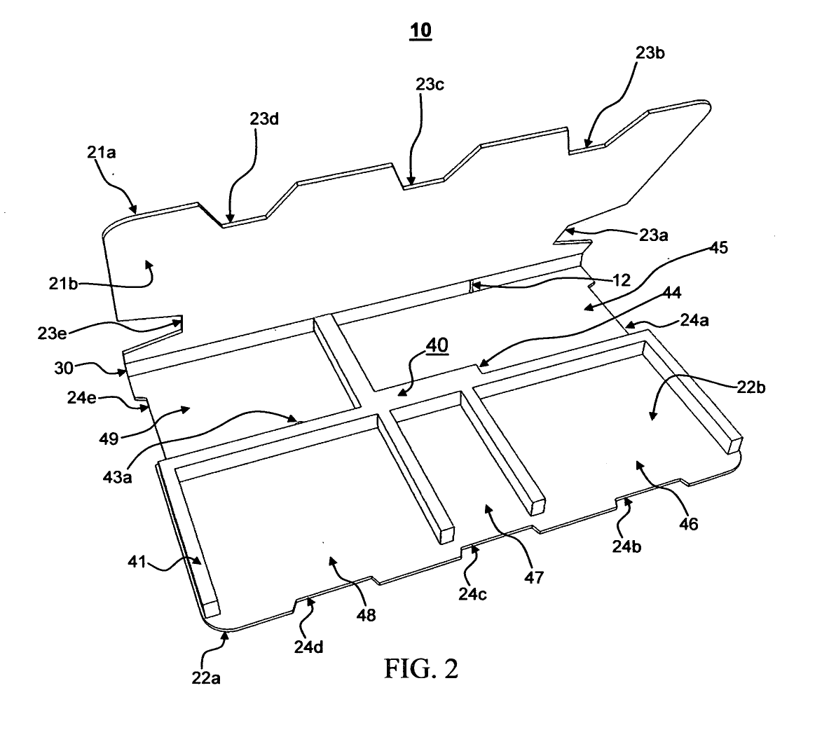

FIG. 2 shows an expanded view of the memory card holder 10 including the core organizer 40 in the location of the assembled end product. The core organizer 40 is constructed as to establish several predetermined sized insertion compartments 45-49 to hold a Memory Stick or SD Card in insertion compartment 45, a mini-wallet or storage sleeve for insertion compartment 46, a USB card reader for insertion compartment 47, a mini-wallet or storage sleeve for insertion compartment 48 and a SD Card for insertion compartment 49. There is a spine surface indentation 11 in rear spine 30 to act as a catch for the SD Card to secure the SD Card in position. Also included in the core organizer is an SD Card stop 44 to hold the SD Card in position within insertion compartment 45. Included in compartment 45 is a lateral projection 43b (not shown here) emanating from the lateral surface of the core organizer to function as a catch for the Memory Stick to ensure that it is held securely in the memory card holder 10. In insertion compartment 49 is also located a lateral projection 43a emanating from the lateral surface of the core organizer 40 to function as a catch for an SD Card to ensure that it is held securely in the memory card holder 10.

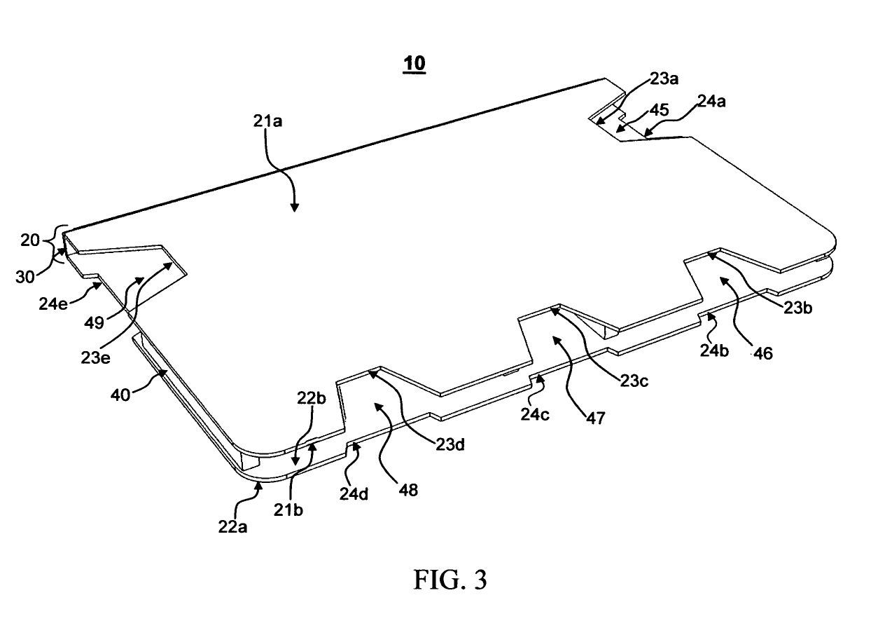

In FIG. 3, the top and frontal view of the memory card holder 10 is shown. This shows the memory card cover 20, upper notches 23a, b, c, d and e and lower notches 24a, b, c, d, and e, rear spine 30, and five (S) insertion compartments 45, 46, 47, 48, and 49 for inserting memory cards, mini wallets 50 (not shown here) and Storage Sleeves 80 (not shown here). Insertion compartment 45 is designed to accommodate a Memory Stick or an SD card. Insertion compartment 46 can accommodate a mini wallet 50 or a Storage Sleeve 80. In insertion compartment 47, a USB reader can be inserted. Insertion compartment 48 is identical to compartment 46 and is used for holding a mini wallet 50 or a Storage Sleeve 80. The entire surface of the memory card cover is suitable to contain graphic designs, logos, business cards, promotional applications or custom designs.

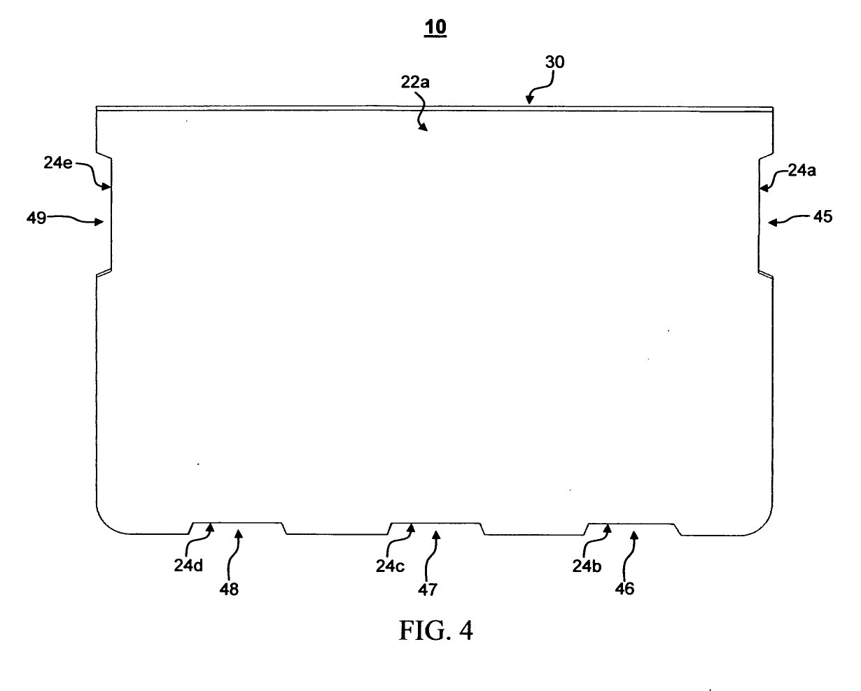

FIG. 4 shows the prospective view of the bottom surface of the memory card holder 10 including the bottom exterior surface 22a of the memory card holder 10 and lower notches 23a, b, c, d and e for each of the Insertion compartments 45-49 and the edge of the rear spine 30.

In FIG. 5 the elevational view of the rear spine 30 of the memory card holder is shown including the top exterior surface 21a and bottom exterior surface 22a of the memory card holder 10 are as indicated. A spine surface indentation 11 shows the location of a flange like projection 12 in compartment 45 to secure an SD card.

In FIG. 6, the dimensions of the various components of the core organizer are shown. Slight deviations from these values do not alter the scope of the present invention. The present invention may be modified regarding the dimensions of the compartments of the core organizer 40 to accommodate newly issued memory cards of slightly different dimensions.

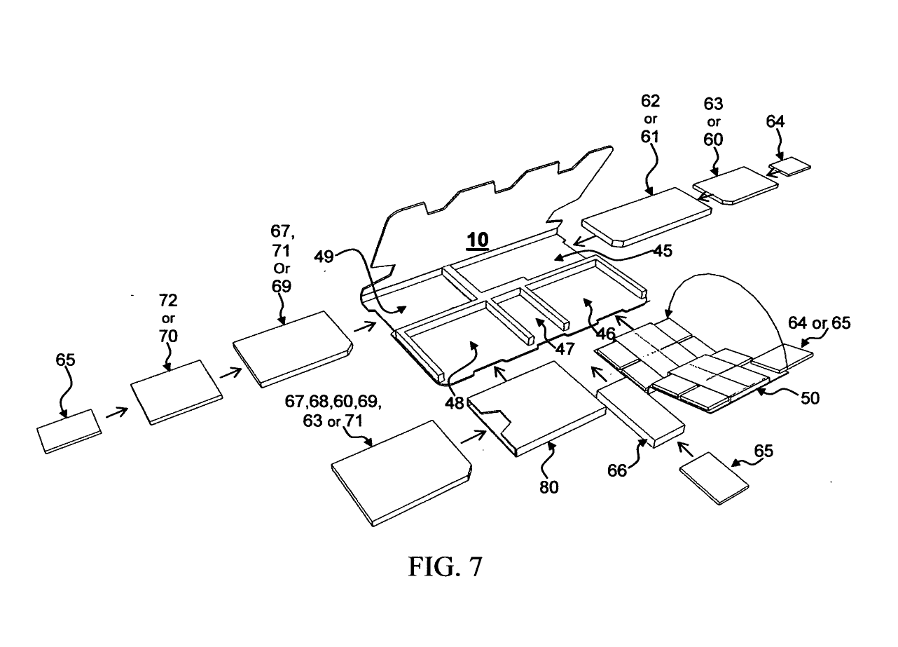

FIG. 7 shows another embodiment of the memory card holder 10 which includes commercially available memory cards and commercially available adaptors. The core organizer 40 defines insertion compartments 45-49. Compartment 45 can hold either a Memory Stick 62 or a Memory Stick Duo Adaptor 61 which can then hold a Memory Stick PRO Duo Adaptor 63 which can then hold a Memory Stick Micro M2 card 64. The ability to nest adaptors is a key feature of the invention. Compartment 45 can alternately hold an SD card (not shown) and therefore can handle the various configurations described for compartment 49. Compartments 46 and 48 can hold either a Storage Sleeve 80 or a mini-wallet 50. Storage Sleeve 80 can hold memory cards or adaptors such as SD card 67, XD card 68, Memory Stick PRO Duo 60, Mini SD to SD Adaptor 69, Memory Stick PRO Duo Adaptor 63, and Micro SD to SD Adaptor 71. Mini wallet 50 has 8 pockets which can store any combination of up to 8 micro memory cards such as Micro SD cards 65 or Memory Stick Micro M2 cards 64. Compartment 47 can hold a commercially available USB Card Reader 66. Compartment 49 can hold an SD card 67, Micro SD to SD Adaptor 71 or a Mini SD to SD Adaptor 69 which can then hold a Mini SD Card 70 or a Micro SD to Mini SD Adaptor 72 which can then hold a Micro SD card 65. The ability to configure and nest adaptors and cards as described provides an efficient method of carrying numerous adaptors and cards in a very small space thus providing a convenience and versatility that was previously unavailable. This figure shows one of many possible configurations. Also where specific adaptors are so designated, an actual memory card can be stored as an option.

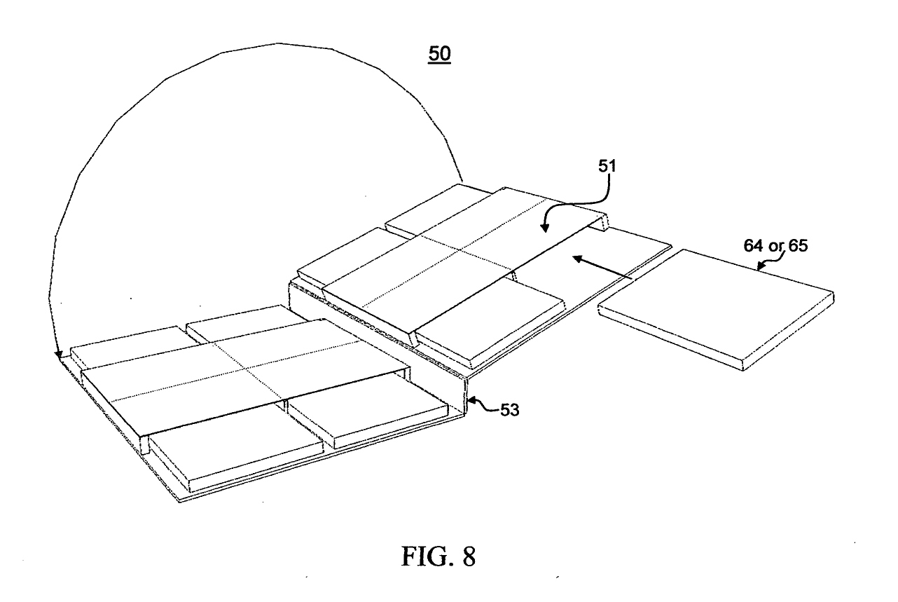

FIG. 8 is an expanded view of the Mini-Wallet 50. The Mini-Wallet 50 includes storage pockets 51 for a plurality of Micro SD cards 65 up to eight (8) in all or a plurality of Memory Stick Micro M2 cards 64, up to eight (8) in all or any combination of Micro SD cards 65 or Memory Stick Micro M2 cards 64 that the available space allows. The Mini-Wallet 50 is made of a polymeric substance such as vinyl or a plastic material, but is not limited to these materials. The Mini-wallet 50 can be either injection molded or vacuum formed. The Mini wallet 50 has a Middle Spine 53 midway between the left and right ends of the interior surface of the Mini wallet 50 that allows the Mini wallet 50 to be opened and closed. The Mini-wallet 50 is formed by a plastic injection molding process. Alternately the mini-wallet 50 may be made with vinyl or Polypropylene, cut to size and heat welded.

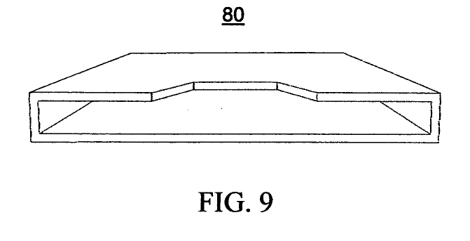

In FIG. 9, a front elevational view of the Storage Sleeve 80 is shown. Storage Sleeve 80 is rectangular container in shape and has a notch located in the top of the sleeve to facilitate the placement and removal of an SD Card, an XD Card or a Memory Stick PRO Duo card. The Storage Sleeve 80 may also store commercially available card adaptors and is not limited to the aforementioned. The storage sleeve 80 is formed by a plastic injection molding process. Alternately the storage sleeve 80 may be made with vinyl or Polypropylene, cut to size and heat welded.

What is claimed is:

1. A portable credit card sized memory card holder (10) comprising:
a) a cover (20) divided into two equally sized top (21) and bottom (22) segments that are contiguous with a centrally located rear spine (30);
b) a plurality of notches located on the top (23) and bottom (24) segments of the cover (20); and
c) a core organizer (40) bonded between the top (21) and bottom (22) segments of the cover (20) forming a plurality of insertion compartments to store a plurality of memory cards.

2. The memory card holder (10) as in claim 1, wherein the upper notches (23a-24a) are larger than the lower notches (23b-29b) to facilitate the easy removal of stored memory cards from the memory card holder (10) and provide greater protection from the elements.

3. The memory card holder (10) as in claim 1, wherein rear spine (30) has an indentation (12) to form a flange like projection (12).

4. The memory card holder (10) as in claim 1, wherein its dimensions are approximately 3⅛ inches in length×2⅛ inches in width× 5/32″ inches in depth.

5. The memory card holder (10) as in claim 1, wherein the core organizer (40) includes as many as five insertion compartments (45-49).

6. The memory card holder (10) as in claim 1, wherein the core organizer (40) includes a lateral projection (43b) that projects upwards two thirds of the distance from the bottom surface of cover (20) to the top surface of cover (20) in insertion compartment (45).

7. The memory card holder (10) as in claim 1, wherein the core organizer (40) includes a lateral projection (43a) in insertion compartment (49).

8. A memory card holder comprising:
a) a cover (20) divided into two equally sized top (21) and bottom (22) segments that are contiguous with a centrally located rear spine (30);
b) a plurality of notches located on the top (23) and bottom (24) segments of the cover (20); and
c) a core organizer (40) bonded between the top (21) and bottom (22) segments of the cover (20) forming a plurality of insertion compartments to store a plurality of memory cards
d) a plurality of insertion compartment storage devices to enable nesting of memory cards of various sizes.

9. The memory card holder (10) as in claim 8, wherein the upper notches (23a-29a) are larger than the lower notches (23b-29b) to facilitate the easy removal of stored memory cards from the memory card holder (10) and provide greater protection from the elements.

11. The memory card holder (10) as in claim 8, wherein rear spine (30) has an indentation (12) to form a flange like projection (12).

12. The memory card holder (10) as in claim 8, wherein its dimensions are approximately 3⅛ inches in length×2⅛ inches in width× 5/32″ inches in depth.

13. The memory card holder (10) as in claim 8, wherein the core organizer (40) includes five insertion compartments (45-49).

14. The memory card holder (10) as in claim 13, wherein the core organizer (40) includes a lateral projection (43b) that projects upwards two thirds of the distance from the bottom surface of cover (20) to the top surface of cover (20) in insertion compartment (45).

15. The memory card holder (10) as in claim 8, wherein the core organizer (40) includes a lateral projection (43a) in insertion compartment (49).

16. The memory card holder as in claim 8, wherein the insertion compartment (45) accommodates a Memory Stick Duo Adaptor (61) that receives a Memory Stick PRO Duo (60) device or a Memory Stick PRO Duo Adaptor (63) for a Memory Stick Micro M2 card (64) device.

17. The memory card holder of claim 8, wherein insertion compartment (46) and (48) receives a mini-wallet (50) that enables nesting of a plurality of Memory Stick Micro M2 cards (64) and/or Micro SD cards (65) or a Storage Sleeve (80) that can accommodate a Memory Stick PRO Duo (60), a Memory Stick PRO Duo Adaptor (63), a SD card (67), a XD card (68), a Mini SD to SD Adaptor (69), or Micro SD to SD Adaptor (71).

18. The memory card holder of claim 8, wherein insertion compartment (49) receives a Micro SD card (65), a Mini SD Card (70) or a Micro SD to Mini SD Adaptor (72), a SD card (67) or a Mini SD to SD Adaptor (69), and Micro SD to SD Adaptor (71).

19. The memory card holder of claim 8, wherein the mini wallet (50) folds in half at a centrally located spine (53) and contains a plurality of pockets to hold Memory Stick Micro M2 cards (64) and or Micro SD cards (65).

20. The memory card holder of claim 8, wherein Storage Sleeve (80) is a rectangular shaped storage adaptor for a Memory Stick PRO Duo (60), a Memory Stick PRO Duo Adaptor (63), a SD card (67), a XD card (68), a Mini SD to SD Adaptor (69) or a Micro SD to SD Adaptor (71).
